(19) United States
(12) Patent Application Publication
(10) Pub. No.: US 2009/0132098 A1
(43) Pub. Date: May 21, 2009

(54) Method and System for Deployed Shielding Against Ballistic Threats

(75) Inventor: Avraham Leshem, Rishon LeZion (IL)

Correspondence Address: OLIFF & BERRIDGE, PLC, P.O. BOX 320850, ALEXANDRIA, VA, 22320-4850, US

(73) Assignee: ELTA SYSTEMS LTD, ASHDOD (IL)

(21) Appl. No.: 12/083,371

(22) PCT Filed: Oct. 15, 2006
(86) PCT No.: PCT/IL2006/001182

§ 371 Date: Jun. 23, 2008

(30) Foreign Application Priority Data
Oct. 11, 2005 (IL) 171361

(51) Int. Cl. G05D 1/12; F41H 5/06

(52) U.S. Cl. 700/302; 89/36.07

(57) ABSTRACT

A system shields field-deployable equipment from effects of nearby multi-directional threats, the equipment including or being mounted in association with a sensor unit having at least one sensor operable to detect the motion of an in-flight projectile and to generate a nearby impact point determination. Shields are mounted in spaced relationship with the equipment and adapted to be moved from first position wherein the equipment is fully exposed to a second position wherein the equipment is at least partially shielded, and a control unit is coupled to the shields and is responsive to detection of an in-flight projectile prior to nearby impact for moving at least one of the shields from the first position to the second position.

### FIELD OF THE INVENTION

This invention relates to systems and methods which provide ballistic shielding. This invention relates more particularly to shielding a unit having sensor capabilities from ballistic and blast effects caused by incoming threats.

### BACKGROUND OF THE INVENTION

Units positioned in a field of multi-directional threats, such as in the battlefield, are frequently under the dangers of direct hits of bombs, rockets, missiles, incoming weapons fire and the like. The indirect effects of shrapnel, debris and fireballs as a result of a nearby hit or explosion of said multi-directional threats can be equally detrimental to the survival and operability of the unit.

To address such threats numerous methods and systems are known to be used for blast mitigation purposes. Examples include bullet-proof casings, concrete and steel building structures, armor plates, and others. The particular avenue taken depends upon factors such as degree and likelihood of threat, required mobility of the unit to be protected, the effect of the protective shielding upon the operability of the unit and other similar considerations.

The characteristics of the threat are also taken into account. For instance, radar units are often detected by radiation homing devices. Such devices which home into the radiation beacon of the radar can have an extremely high rate of successful direct impacts. The threats of such radiation homing devices may be mitigated by decoy and deception targets and techniques which are not subject matter of the present invention, although shielding the unit under threat by a physical barrier may prove effective also with regards to threats directed by homing devices.

Since units such as radar sensor units require a large field of visibility, traditional heavy-duty protective barrier shielding techniques are often not practical. Shielding a radar sensor unit with surrounding concrete and steel walls will most likely render the unit useless, for such walls block the line of sight of the radar sensor. Various RF transparent materials are known to be used in protective radomes fitted around the radar unit's antenna, but these provide limited protection from environmental conditions and do not provide any solution against ballistic and blast effects.

Some conventional object restraining systems and methods are known which control and prevent damage to a unit from nearby impact threats after deployment of various kinds of shields. Where transparency is not a factor but only short term shielding is desired, various methods and devices are known to be utilized for temporary placement of a shield over a potential target which is to be protected. Such devices include cylindrical telescopic rings or inflatable detonation protection air-bags, as disclosed in US 2004/0216593 and U.S. Pat. No. 6,595,102, respectively. However these methods of protection render the protected unit inoperable for the duration of the protection and once used and thereafter removed the shielding device cannot be repositioned against later detected threats.

Thus there is need in the art for a system and a method providing adequate intervening protection between a unit to be protected and a rapidly-approaching, potentially lethal object, expected to hit in the vicinity of the unit, while allowing continued operation of the unit during use.

### SUMMARY OF THE INVENTION

It is therefore an object of the invention to provide a system and a method providing adequate intervening protection between a unit to be protected and a rapidly-approaching, potentially lethal object, expected to hit in the vicinity of the unit, while allowing continued operation of the unit during use.

This object is realized in accordance with an aspect of the invention by a system for shielding a field-deployable equipment from effects of nearby multi-directional threats, said equipment including or being mounted in association with a sensor unit having a sensor operable to detect the motion of an in-flight projectile and to generate a nearby impact point determination, said system comprising:

one or more shields capable of being mounted in spaced relationship with the equipment and adapted to be moved from a first position wherein the equipment is fully exposed to a second position wherein the equipment is at least partially shielded, and

a control unit coupled to each of the shields and being responsive to detection of an in flight projectile prior to nearby impact for moving at least one of said shields from said first position to said second position.

Such a system should be capable of protecting incoming ballistic projectiles or other objects traveling at high speed towards or close to the unit, discriminating the presence of the incoming, dangerous object from other airborne particles or objects, and activating/deploying a suitable protective device thereby reducing or eliminating the risk of impact between the object or its ballistic effects and the protected unit. The system should make use of readily available information collected by the sensor unit and use it to control the deployment of the shielding. An advantage of such a system is that the deployed shielding has minimal effect upon the operability of the protected unit.

In one exemplary embodiment of the invention, the sensor units are radar units responsive to RF signals and the shields are of a high-strength material construction capable of substantially inhibiting blast effects from passing therethrough and at the same time having sufficient RF transparency for a radar unit to continue and analyze incoming threats and to a certain extent to carry out regular search and track tasks.

The control unit is responsive to a signal received from a sensor unit to determine the degree of risk of potential ballistic threats and to determine the necessity for deploying the relevant shields. Owing to the transparency of the shields to the sensor signal, a sensor unit can continue to analyze the threats in the field and the control unit can determine whether to sustain the deployment of the shields, add shielding from angle directions not yet deployed, or stow all or part of the shields deployed.

The present invention is effective for protecting mainly against nearby impact debris and also partially direct hits, such as bullets.

### BRIEF DESCRIPTION OF THE DRAWINGS

In order to understand the invention and to see how it may be carried out in practice, an embodiment of a protective system for shielding a radar unit will now be described, by way of non-limiting example only, with reference to the accompanying drawings, in which:

FIG. 1 is a pictorial representation showing a sensor unit positioned in the field with surrounding shields deployable by a control unit;

FIG. 2a is a pictorial representation showing the shields in a stowed position whereby the unit is unprotected;

FIG. 2b is a pictorial representation showing the shields in a fully erect position whereby the circumference of the unit is protected;

FIG. 2c is a pictorial representation showing the shields in a partially erected position; and

FIGS. 3a and 3b are flow diagrams showing the main operations carried out by the control unit of the system shown in FIG. 1.

### DETAILED DESCRIPTION OF EMBODIMENTS

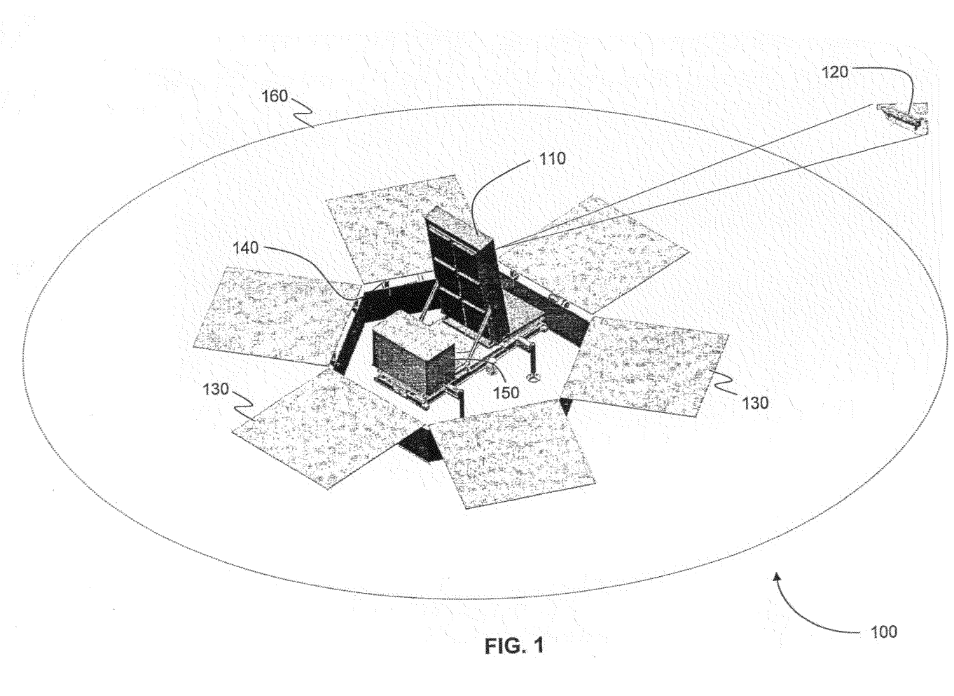

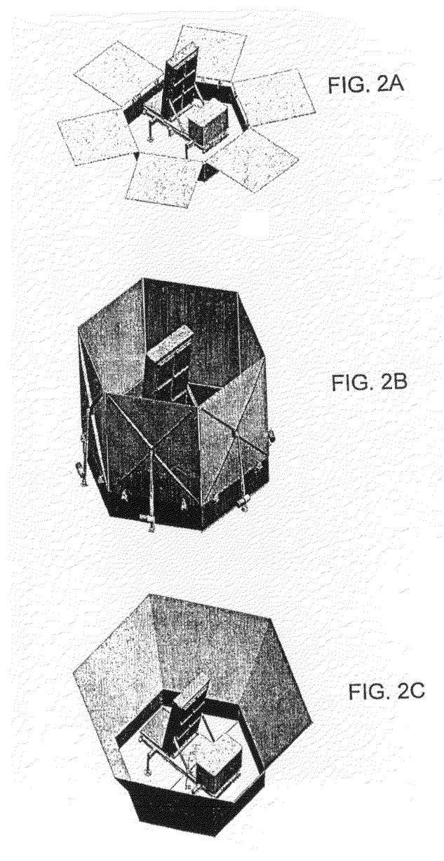

FIG. 1 is a perspective view showing a system 100 in its regular operational state for protecting a radar unit 110 (constituting a sensor unit) against attack by potential aerial targets, such as the target 120. The system 100 includes a plurality of deployable shields 130 (constituting primary shields) that may be installed in the field so as to surround the radar unit 110 and, when deployed by respective actuators shown schematically as 140 controlled by a control unit 150, shield the radar unit 110 against incoming ballistic objects. FIG. 2a shows the shields in a stowed position whereby the radar unit is unprotected. FIG. 2b shows the shields in a fully erect position whereby the circumference of the radar unit is protected. FIG. 2c shows the shields in a partially erected position, which offers substantial protection to the radar unit, while allowing the shields to be returned more quickly to their first stowed position once no more threats are detected.

The shields may be rectangle plates 130 dimensioned such that when erected they transcend the height of the radar unit 110 as shown in FIG. 2b. Alternative embodiments of the present invention as presented in FIG. 2c show plates tilted so as to deflect shrapnel and debris towards the ground thus possibly preventing secondary damage to neighboring objects or people.

FIG. 2b shows an exemplary embodiment where all the shields 130 surrounding the radar unit 110 are deployed on identifying a threat. In an alternative embodiment only those shields are deployed that are required to protect the radar unit 110. The deployment of fewer shields reduces the degradation of the operability of the radar unit and requires less power for the rapid deployment of the shields. Such determination can also be made by rating which parts or areas of the radar unit should be protected first and which should be afforded lesser priority. For example, leaving the protection of the antenna to the last will provide minimal disruption of operation. According to such rating an order of deploying shields can be established.

The shields may be formed from ceramic composite plates, although alternative embodiments may use other composites or other protective materials to both provide proper antiballistic protection from destructive objects, while at the same time enabling continued RF reception of the radar signal (constituting a sensor signal) at minimal loss. These materials can be fabricated and configured in many ways and forms to conform to the shape of the object to be protected. The thickness of the anti-ballistic material can be varied and should be chosen to match the relevant threats in the field, while taking into account the need for minimum RF loss. By way of example, ceramic plates having a thickness of 29 mm and mass of 50 Kg/m² result in 0.5 dB-1 dB temporary one way RF loss on raising the shields.

For the purposes of this discussion, the term “rapid employment” means that a anti-ballistic shield becomes sufficiently deployed so as to effectively protect the radar unit from an approaching threat, which was identified and determined by the control unit to impact within a circular error probability (CEP) 160 that would cause damage to the unit, within a time period less than 5 seconds. Using ceramic plates of the materials discussed above, this can be achieved when the actuator 140 employs a helical gear motor of a size in the range of 1.5×0.3×0.7 meters and mass of 800 Kg. The actuators 140 should optimally be configured to maintain the shields in a deployed position upon impact.

The impact point prediction accuracy of the sensor is a function of the track duration and the proximity of the impact. By way of example, 5 seconds of tracking enables determination of a CEP less than 100 meters (depending on the radar parameters); while a longer tracking time allows the CEP to be narrowed to 50 meters. Tracking 10 seconds before impact reduces the CEP to 25 meters since the closer the CEP is measured to the actual impact, the more accurately it can be determined. The protection needed and the timing of its deployment may therefore be determined according to the current projected CEP taking into account the type of the incoming threat.

In the exemplary embodiment described above with reference to FIGS. 1 and 2 of the drawings, a radar sensor unit is employed having an output conduit that is monitored by the control unit 150 so as to generate an actuation signal on detecting a nearby impact point within a CEP of damage. The actuation signal is fed to the actuator or actuators 140 which deploy one or more of the shields 130. The deployed shields are returned to their first stowed position once no more threats are detected.

Phased array radar systems are well adapted to perform other tasks including detecting an incoming threat 120 and enabling the analysis and determination by a control unit of the threat having a nearby impact point (IP) within a CEP which can cause damage to the radar unit 110. Although, also a non-phased array radar system may be used to detect such threats, using a phased array radar system has benefits in dense scenarios as well as the benefit of carrying out other tasks in parallel.

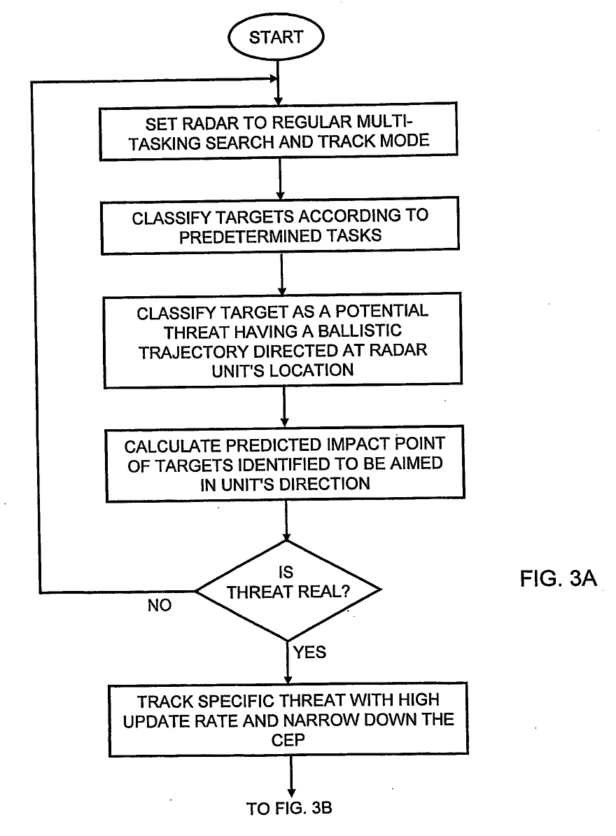

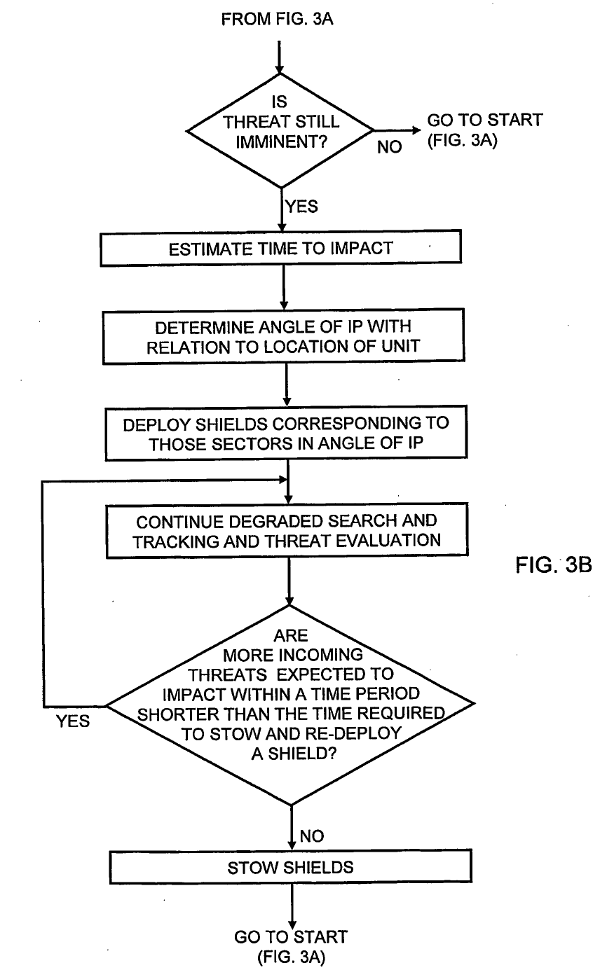

FIGS. 3a and 3b are flow diagrams showing the main operations carried out by the control unit 150 shown in FIG. 1. Initially, the radar unit 110 is set to regular multi-tasking search and track mode and classifies targets according to predetermined tasks. The control unit 150 classifies a target as a potential threat having a trajectory directed at radar unit's location and calculates the predicted impact point (IP) of targets identified to be aimed in the direction of the radar unit 110. The control unit 150 further classifies type of threat according to its properties (e.g. trajectory, velocity, size, etc.) and checks whether the predicted IP is within the CEP of damage according to type of threat. If negative, control returns to the start of the algorithm so as to process new incoming potential threats. If affirmative, thus representing a real threat, the control unit 150 sets the radar unit 110 to track the specific threat with a high update rate and narrows down the CEP. The control unit then checks whether the predicted IP is still within the CEP of damage according to the type of threat. If negative, control returns to the start so as to process new incoming potential threats. If affirmative, thus representing a real threat, the control unit 150 sets estimates time to impact and determines the angle of the impact point (IP) relative to the location of the radar unit 110. It then deploys the appropriate shields by actuating, as late as possible, those shields corresponding to the relevant sector to be protected according to predetermined angle of the impact point. This done, the control unit 150 continues to perform degraded search and tracking tasks and threat evaluation. Such tasks are degraded because the shields are now deployed and block RF. On evaluating a new threat, it checks whether such threats are expected to impact within a time period shorter than the time required to stow and then re-deploy a shield. If affirmative, the shields are left deployed and the control unit 150 continues the degraded search and evaluation. Otherwise, the control unit 150 sends a signal to the actuators 140 for stowing shields after which control return to the start of the algorithm.

In an exemplary embodiment of the present invention, detection of a threat with an expected nearby impact point does not involve relinquishing other tasks, and the radar unit may continue to operate after the ceramic plates are deployed with a degradation in its performance of about 10%.

In the exemplary embodiment the destructive object detection system employs a radar sensor, but it will be appreciated that the principles of the invention are equally applicable for protecting other field-mounted sensors or indeed other non-sensory field-deployable equipment on, or in association with which, sensors are mounted that are capable of detecting an impending impact. By such means, field-deployable equipment can be better protected against the effects of direct or near impacts.

Likewise, auxiliary field-deployable equipment that is near to the shielded sensor unit 110 can be protected by means of an additional set of one or more shields (constituting auxiliary shields) mounted in spaced relationship with a sensor unit neighboring the auxiliary equipment and controlled by the control unit 150 of the shielded sensor unit 110 from a stowed to deployed position and vice versa. The present invention can be incorporated together with other protective techniques such as decoy and deception methods and anti-jamming electronics to provide a unit with a full suite of protection.

Although the present invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is, therefore, contemplated that the appended claims will cover such modifications that fall within the scope of the invention.

For example, in the exemplary embodiments described, the shields are formed of a material that is substantially transparent to the sensor signal so as to allow the sensor to continue operating even when one or more of the shields are deployed. However, according to an alternative and less expensive embodiment, the shields may be opaque to the radar signal and may be deployed immediately prior to a computed time of impact and thereafter returned to their normal position. In such an embodiment, the radar unit will suffer intermittent loss but there may be occasions when this can be tolerated, in which case less expensive materials can be used for the shields. In such circumstances, it may be desirable to interrupt radar transmission while the shields are deployed so as to prevent back reflection of the radar signal towards the radar unit in the event that the shields are formed of a material (such as metal) that is reflective to the radar signal.

Finally, it will also be understood that the control unit 150 may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A system for shielding field-deployable equipment from effects of nearby multi-directional threats, said equipment including or being mounted in association with a sensor unit having at least one sensor operable to detect the motion of an in-flight projectile and to generate a nearby impact point determination, said system comprising:
one or more primary shields capable of being mounted in spaced relationship with the equipment and adapted to be moved from a first position wherein the equipment is fully exposed to a second position wherein the equipment is at least partially shielded,
a control unit coupled to each of the primary shields and being responsive to detection of an in flight projectile prior to nearby impact for moving at least one of said primary shields from said first position to said second position, and
wherein the control unit is responsive to an absence of a threat for a predetermined time for moving at least one of said primary shields from said second position to said first position.

2. The system according to claim 1, further including one or more auxiliary shields mounted in spaced relationship with a sensor unit neighboring auxiliary equipment and controlled by said control unit.

3. The system according to claim 1, further including one or more auxiliary shields mounted in spaced relationship with a non-sensory unit neighboring the sensor unit and controlled by said control unit.

4. (canceled)

5. The system according to claim 1, wherein the sensor unit is a radar unit.

6. The system according to claim 1, wherein the sensor unit has multi-tasking capabilities.

7. The system according to claim 1, wherein the control unit is responsive to a predicted impact point of said projectile for selecting at least one of said shields to be moved to said second position.

8. The system according to claim 1, wherein the control unit is responsive to a threat for moving all of the shields to said second position.

9. The system according to claim 1, wherein at least one of the shields may be tilted.

10. The system according to claim 1, wherein the shields are formed of a material that is substantially transparent to a sensor signal detected by the at least one sensor so as to allow the sensor to continue operating even when one or more of the shields are deployed.

11. The system according to claim 10, wherein the shields are made of ceramic composite material.

12. The system according to claim 1, wherein the shields are moved from the first position to the second position in less than 5 seconds.

13. The system according to claim 1, wherein the sensor unit is integral with the equipment being shielded.

14. The system according to claim 13, wherein the equipment is constituted by the sensor unit.

15. The system according to claim 1, wherein the control unit is adapted to evaluate after deployment of one or more shields whether a new incoming threat is expected to impact within a time period shorter than the time required to stow and then re-deploy said one or more shields, and for controlling the actuators for stowing said one or more shields if no such threat is evaluated.

16. A method for shielding field-deployable equipment unit from effects of near miss multi-directional threats, said equipment including or being mounted in association with a sensor unit having a sensor operable to detect the motion of an in-flight projectile and to generate a nearby impact point determination, said method comprising:
mounting one or more primary shields in spaced relationship with the equipment; and
moving at least one of said primary shields from a first position wherein the sensor unit is fully exposed to a second position wherein the sensor unit is at least partially shielded in response to detection of an in flight projectile prior to near-by impact; and
moving at least one of said shields from said second position to said first position if no threat is detected for longer than a predetermined time duration.

17. The method according to claim 16, including:
mounting one or more auxiliary shields in spaced relationship with a sensor unit neighboring auxiliary equipment; and
controlling the auxiliary shields to be moved from the first position to the second position together with the primary shields.

18. The method according to claim 16, including:
mounting one or more auxiliary shields in spaced relationship with a non-sensory unit neighboring the sensor unit; and
controlling the auxiliary shields to be moved from the first position to the second position together with the primary shields.

19. (canceled)

20. The method according to claim 16, wherein the sensor unit is a radar sensor unit.

21. The method according claim 16, wherein the sensor unit has multi-tasking capabilities.

22. The method according claim 16, including selecting at least one of said shields to be moved to said second position in accordance with a predicted impact point of said projectile.

23. The method according to claim 16, including moving all of the shields to said second position responsive to a threat.

24. The method according to claim 16, including tilting at least one of the shields.

25. The method according to claim 16, including forming the shields of a material that is substantially transparent to a sensor signal detected by the at least one sensor so as to allow the sensor to continue operating even when one or more of the shields are deployed.

26. The method according to claim 25, including forming the shields of ceramic composite material.

27. The method according to claim 16, including moving the shields from the first position to the second position within less than several seconds.

28. The method according to claim 16, including:
(a) setting the sensor unit to search and track mode;
(b) classifying a target as a potential threat having a trajectory directed toward a vicinity of the sensor unit;
(c) calculating predicted impact point of target;
(d) classifying threat according to its risk;
(e) tracking a high risk threat and recalculating predicted impact point of target;
(f) estimating time of impact of threats that remain high risk;
(g) determine direction of impact relative to sensor unit;
(h) deploying one or more shields corresponding to those sectors in line of impact;
(i) continuing search and tracking with said one or more shields deployed; and
(j) stowing deployed shields upon termination of threat.

29. The method according to claim 28, further including classifying a target according to predetermined tasks.

30. The method according to claim 28, further including prior to stowing deployed shields:
i) evaluating whether a new incoming threat is expected to impact within a time period shorter than the time required to stow and then re-deploy said one or more shields, and
ii) controlling the actuators for stowing said one or more shields if no such threat is evaluated.

31. (canceled)

32. (canceled)

33. A computer program product comprising a computer useable medium having computer readable program code embodied therein for shielding field-deployable equipment unit from effects of near miss multi-directional threats, said equipment including or being mounted in association with a sensor unit having a sensor operable to detect the motion of an in-flight projectile and to generate a nearby impact point determination, said computer program product comprising:
computer readable program code for causing the computer to identify and register one or more primary shields in spaced relationship with the equipment; and
computer readable program code for causing the computer to move at least one of said primary shields from a first position wherein the sensor unit is fully exposed to a second position wherein the sensor unit is at least partially shielded in response to detection of an in flight projectile prior to near-by impact; and
computer readable program code for causing the computer to move at least one of said shields from said second position to said first position if no threat is detected for longer than a predetermined time duration.
